(19) United States
(12) Patent Application Publication
(10) Pub. No.: US 2011/0176861 A1
(43) Pub. Date: Jul. 21, 2011

(54) JOINT STRUCTURE FOR TOY

(75) Inventors: Kenji NAKAYAMA, Tokyo (JP); Tomohito Nagai, Tokyo (JP)

(73) Assignee: TOMY COMPANY, LTD., Tokyo (JP)

(21) Appl. No.: 12/943,295

(22) Filed: Nov. 10, 2010

(30) Foreign Application Priority Data
Jan. 15, 2010 (JP) 2010-006633

(51) Int. Cl. F16C 11/06

(52) U.S. Cl. 403/122

(57) ABSTRACT

A joint structure for a toy, including, a male body including, two hemispherical sliding surfaces formed mutually concentrically and having a same central axis, and a female body, coupled to the male body with the male body and the female body rockable with each other, the female body including, a first female body having a hemispherical first surface to be slid complementary to one of the two sliding surfaces, and a second female body having a hemispherical second surface to be slid complementary to the other of the two sliding surfaces, wherein the first female body and the second female body nip the male body, with the one sliding surface and the first surface to be slid, slidable on each other, and with the other sliding surface and the second surface to be slid, slidable on each other.

### BACKGROUND OF THE INVENTION

1. Field of the Invention

The present invention relates to a joint structure for a toy.

2. Description of Related Art

As a conventional joint structure for a toy which couples two parts, with the two parts capable of relatively rocking, a so-called ball joint structure, as shown in FIG. 9, has been known. In the ball joint structure, a spherical ball member 101, attached to a rocking member 100 on one side, is fitted to a circular sliding surface 102a formed on a rocking member 102 on the other side (see, for example, Japanese Patent Publication No. 3798350).

In such a ball joint structure, however, the ball member 101, which is a sliding portion, must be provided as a body separated from the rocking members 100 and 102, and the number of parts cannot be decreased. Furthermore, if a force is applied to the ball member 101 into the direction for making the ball member 101 drop off from the rocking member 102, the ball member 101 sometimes drops off relatively easily.

### SUMMARY OF THE INVENTION

It is, therefore, a main object of the present invention to provide a joint structure for a toy capable of preventing the dropping-off of a sliding portion, with the number of parts decreased.

According to an aspect of the present invention, there is provided a joint structure for a toy, including, a male body including, two hemispherical sliding surfaces formed mutually concentrically and having a same central axis, and a female body, coupled to the male body with the male body and the female body rockable with each other, the female body including, a first female body having a hemispherical first surface to be slid complementary to one of the two sliding surfaces, and a second female body having a hemispherical second surface to be slid complementary to the other of the two sliding surfaces; wherein the first female body and the second female body nip the male body, with the one sliding surface and the first surface to be slid, slidable on each other, and with the other sliding surface and the second surface to be slid, slidable on each other.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is an external view of an automobile toy of an embodiment of the present invention;

FIG. 2 is a plan view of the automobile toy from which a body is removed;

FIG. 3 is a sectional view viewed from arrows A in FIG. 2;

FIG. 4 is a sectional view viewed from arrows B in FIG. 2;

FIG. 5 is a partial sectional view of a rear end portion of the automobile toy;

FIG. 6 is an external view of a remote controller;

FIG. 7 is an external view of a charger;

FIG. 8 is an external view of an automobile toy provided with an overturn prevention ring; and

FIG. 9 is a view to explain a conventional joint structure for a toy.

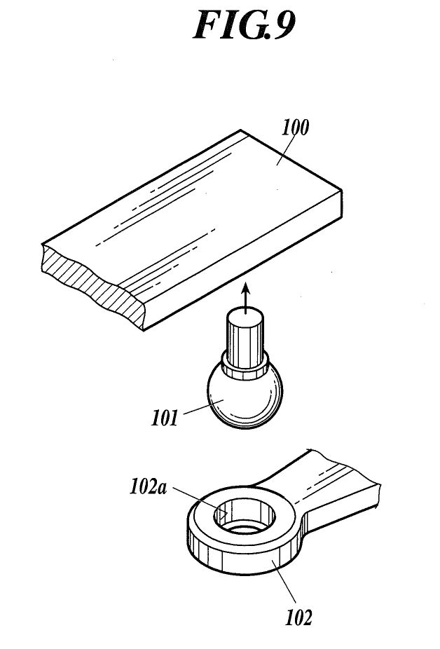

### DESCRIPTION OF THE PREFERRED EMBODIMENTS

In the following, an embodiment of the present invention will be described with reference to the accompanying drawings.

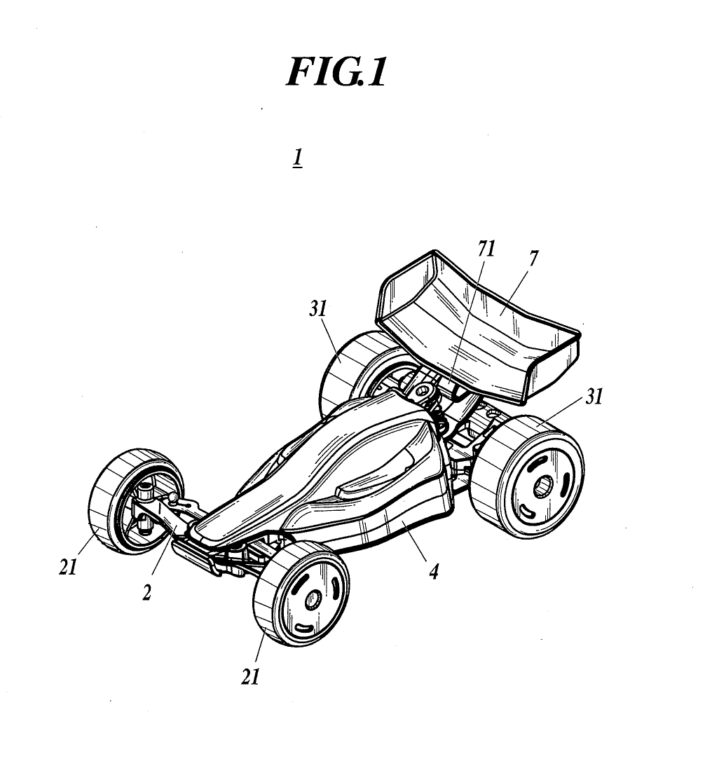

FIG. 1 is an external view of an automobile toy 1 of the present embodiment.

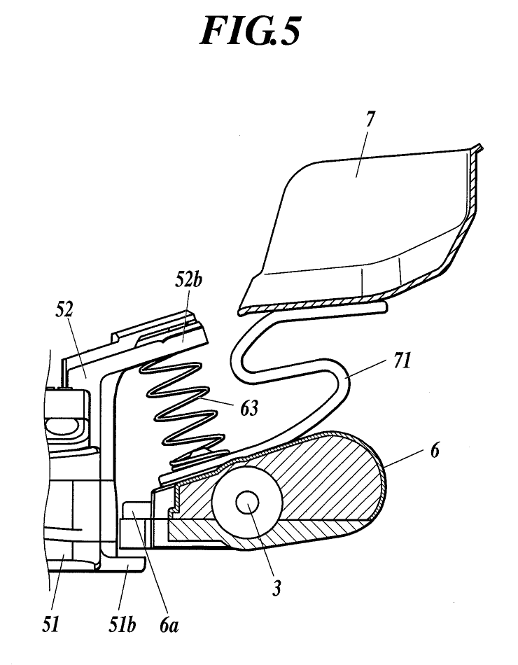

As shown in this figure, the automobile toy 1 is a travelling toy imitating an off-road vehicle and is equipped with a front wheel axle 2 for supporting front wheels 21, 21 to be able to be steered right and left; a rear wheel axle 3 (see FIG. 5) for supporting rear wheels 31, 31; a body 4, and a wing member 7.

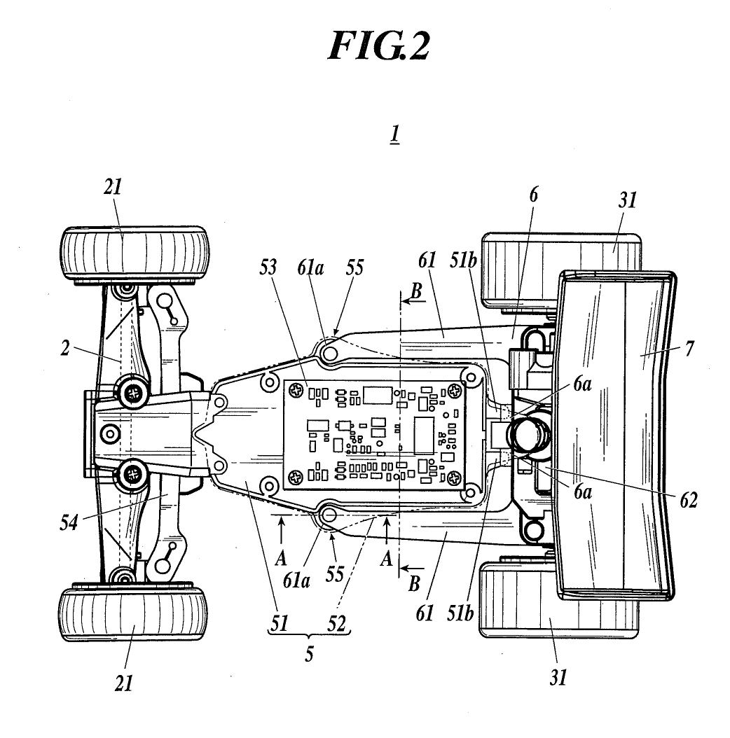

FIG. 2 is a plan view of the automobile toy 1 from which the body 4 is removed.

As shown in this figure, the front wheel axle 2 is supported by a front wheel chassis 5, and the rear wheel axle 3 is supported by a rear wheel chassis 6.

The front wheel chassis 5 is composed of a lower front wheel chassis 51, which is shaped in an almost flat plate and supports the front wheel axle 2 at a front end portion of the front wheel chassis 5, and an upper front wheel chassis 52 (shown by chain double-dashed lines in FIG. 2), covering a central portion of the automobile body of the lower front wheel chassis 51. The lower front wheel chassis 51 and the upper front wheel chassis 52 engage with each other. An electric circuit board 53 which receives a control signal from a remote controller 8, described later, to drive each portion, is placed on the lower front wheel chassis 51, and the electric circuit board 53 is covered by the upper front wheel chassis 52. Furthermore, a steering motor and a gear mechanism, which are not shown, are mounted on the lower front wheel chassis 51, and a steering rack 54, coupled to the front wheels 21, 21, is supported in parallel with the front wheel axle 2 so as to be movable in a right and left direction. These parts constitute a steering mechanism of the automobile toy 1. The steering motor drives the steering rack 54 right and left through the gear mechanism, and thereby the front wheels 21, 21 change their directions right and left. The automobile toy 1 is thus steered. Furthermore, a battery, not shown, is mounted on the lower front wheel chassis 51.

On the other hand, a drive motor 62, having a motor shaft coupled to the rear wheel axle 3, is mounted in the rear end portion of the rear wheel chassis 6. The rear wheel chassis 6 includes two arms 61, 61, extending forward along both-side portions of the automobile 1, and the rear wheel chassis 6 is formed in an almost U-shaped in a planar view.

These front wheel chassis 5 and rear wheel chassis 6 are coupled to each other by the two arms 61, 61 in the both-side portions of each of the chassis 5 and 6. Respective end portions 61a (corresponding to a male body) of the two arms 61, 61 are coupled to coupling portions 55 (corresponding to a female body), provided as projections in the both-side portions of the front wheel chassis 5, with the two arms 61, 61 separated from each other in the vehicle width direction, with the rear end portion of the front wheel chassis 5 put between the arms 61, 61.

Furthermore, the upper part of the coupling portion 55 corresponds to a first female body, and the lower part of the coupling portion 55 corresponds to a second female body

In addition, the surfaces of the end portions 61a correspond to hemispherical sliding surfaces, and the surfaces of the coupling portions 55 correspond to a first surface to be slid and a second surface to be slid.

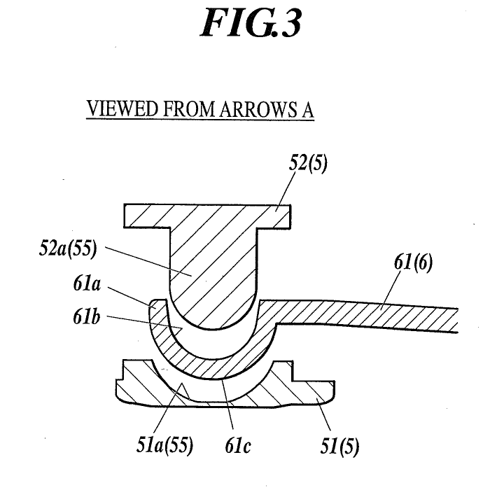

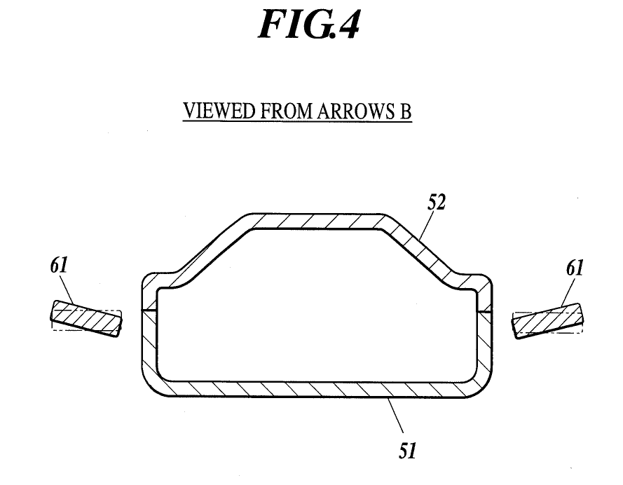

FIG. 3 is a sectional view viewed from arrows A in FIG. 2, and FIG. 4 is a sectional view viewed from arrows B in FIG. 2. In addition, FIG. 3 shows the figure in which gaps between each part are widened in order to make the figure easy to understand.

As shown in FIG. 3, a hemispherical first projecting portion 52a, projecting downward and formed on the upper front wheel chassis 52, and a hemispherical second concave portion 51a, opening upward and formed on the lower front wheel chassis 51, are formed at each of the coupling portions 55. Furthermore, a hemispherical first concave portion 61b, opening upward complementarily to the first projecting portion 52a, and a hemispherical second projecting portion 61c, projecting downward complementarily to the second concave portion 51a, are formed at each of the end portions 61a of the arms 61, 61, with the first concave portion 61b and the second projecting portion 61c mutually concentric. Each of the end portions 61a of the arms 61, 61 is nipped by the upper front wheel chassis 52 and the lower front wheel chassis 51 from above and below in such a way that the first projecting portion 52a and the first concave portion 61b are slidably fitted to each other, and that the second projecting portion 61c and the second concave portion 51a are slidably fitted to each other.

By providing such a coupling structure on the both-side portions, relative rocking between the front wheel chassis and the rear wheel chassis 6 in the horizontal direction and the vertical direction can be allowed, and a road surface following function of the front and rear wheels 21 and 31 and a suspension function of the automobile toy 1 are realized.

Furthermore, each of the two arms 61, 61 is formed in a flat plate inclining toward the inside of the automobile toy 1 in the vehicle width direction in the neighborhood of each of the end portions 61a as shown in FIG. 4. To put it more minutely, each of the arms 61, 61 is formed to be horizontal at its base end portion, shown by chain double-dashed lines in the figure, and to incline more to the inside as its position becomes closer to the end portion 61a thereof. By inclining the arms 61, 61 in this way, even if an external force parallel to the vehicle width direction of the automobile toy 1 is applied to each of the arms 61, 61, the arm 61 can disperse the external force according to the inclination angle thereof, and the load which operates on the arm 61 into the vehicle width direction can be reduced.

Furthermore, each of the two arms 61, 61 is made of a twistable elastic member. Consequently, by the twisting of the arm 61, a twist angle between the front wheel chassis 5 and the rear wheel chassis 6 can be enlarged. In addition, because each of the arms 61, 61 can elastically be deformed into the vertical direction, the suspension function of the automobile toy 1 can be strengthened.

FIG. 5 is a partial sectional view of the rear end portion of the automobile toy 1.

As shown in this figure, the wing member 7 is coupled to the rear wheel chassis 6 through the intermediary of a stay member 71, made of an elastic member. The stay member 71 has a bent portion bent in S in the front and rear direction, and only one stay member 71 is attached to the central part of the wing member 7 in the vehicle width direction (see FIG. 1). By attaching the wing member 7 through the intermediary of such a stay member 71, a local stress concentration on the stay member 71 is moderated, and plastic deformation and breakage of the stay member 71 can be prevented, even if the wing member 7 touches a wall or a road surface owing to an overturn or the like of the automobile toy 1.

One end of a spring member 63 is fixed to the front end portion of the stay member 71, and the other end of the spring member 63 is fixed to a projecting portion 52b at the rear end of the upper front wheel chassis 52. The spring member 63 biases the front wheel chassis 5 and the rear wheel chassis 6 into almost the vertical direction and mainly fulfills the function of a suspension.

Furthermore, locking portions 51b, 51b, projecting rearward, are formed in the rear end portion of the lower front wheel chassis 51, and projections 6a, 6a, projecting forward, are formed over the locking portions 51b, 51b at the front end portion of the rear wheel chassis 6 (see FIG. 2). These locking portions 51b, 51b and projections 6a, 6a are provided for regulating the relative rocking of the front wheel chassis 5 and the rear wheel chassis 6 in the vertical direction around the end portions 61a of the arms 61, 61. By regulating the relative rocking of the front wheel chassis 5 and the rear wheel chassis 6 within a predetermined range in such a way, the end portions 61a of the arms 61, 61 are prevented from being dropped off from the coupling portions 55, and a wiring between the electric circuit board 53 and the drive motor 62 is prevented from being exposed. In addition, the biasing force of the spring member 63 is adjusted so that the locking portions 51b, 51b and the projections 6a, 6a are stabilized in the state of being separated by a predetermined distance in the vertical direction in their normal states.

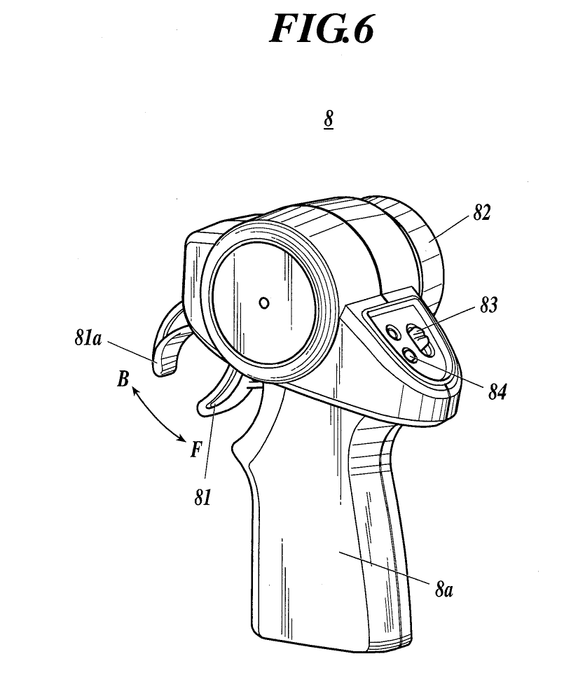

FIG. 6 is an external view of the remote controller 8 for remotely operating the automobile toy 1.

As shown in this figure, the remote controller 8 is equipped with a lever portion 81 for driving the drive motor 62 to advance or reverse the automobile toy 1, and a steering wheel portion 82 for driving the steering motor to steer the automobile toy 1. The present embodiment is configured so that a user operates the lever portion 81 with the left hand grasping a grip portion 8a, and operates the steering wheel portion 82 with the right hand.

When the lever portion 81 is moved from its neutral state into the F direction in the figure, the automobile toy 1 is advanced. When the lever portion 81 is moved from its neutral state into the B direction in the figure, the automobile toy 1 is reversed after being braked for a predetermined time. Furthermore, a projecting portion 81a is formed in the B-direction part of the lever portion 81 which projects into the direction (front side of FIG. 6) opposite to the steering wheel portion 82. Thereby, the remote controller 8 is configured so that an operating finger (for example, the forefinger of the left hand) does not easily slip out at the time of operating the lever portion 81 into the B direction.

The steering wheel portion 82 is configured to be able to drive the steering motor to steer the automobile toy 1 to the left and the right sides by being rotated from its neutral state to the left or the right directions.

Furthermore, the remote controller 8 is equipped with a frequency setting button 84 for switching the operable automobile toy 1, besides an electric power switch 83. By depressing the frequency setting button 84 while a setting signal is output from the automobile toy 1, a setting can be made where the operation of the automobile toy 1, outputting the setting signal, is allowed.

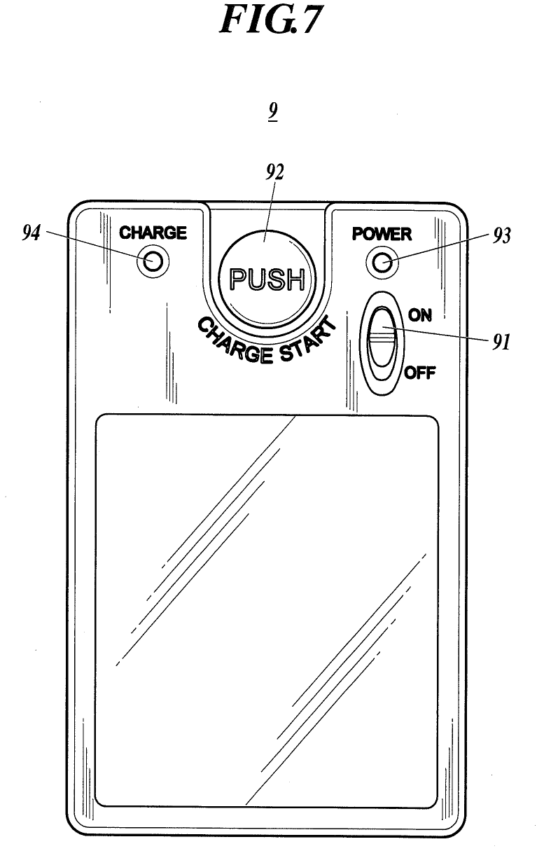

FIG. 7 is an external view of a charger 9 for charging the battery of the automobile toy 1.

As shown in this figure, the charger 9 is equipped with an electric power switch 91 and a charge starting button 92, and is configured to be able to charge the battery of the automobile toy 1 by supplying electric power from a built-in battery, not shown, to the battery of the automobile toy 1, by turning on the electric power switch 91 and depressing the charge starting button 92 in the sate of connecting a charging cable, not shown, to the automobile toy 1. Furthermore, the charger 9 is equipped with a power source light emitting diode (LED) 93 and a charging LED 94. Whether the power source is on or off can be judged by whether the light of the power source LED 93 is on or off, respectively. Further, whether the charging state of the charger 9 is “during charging” or “completion” can be judged by whether the light of the charging LED 94 is on or off, respectively.

According to the aforesaid automobile toy 1, the front wheel chassis 5 and the rear wheel chassis 6 (arms 61, 61) are rockable with each other, with the hemispherical concave surfaces and the hemispherical projecting surfaces, which are formed on the chassis 5 and 6, sliding with each other. Consequently, it is unnecessary to provide a sliding portion as a separated body, which is different from the conventional art, and therefore, the number of parts can be decreased. Furthermore, because the upper front wheel chassis 52 and the lower front wheel chassis 51 nip the end portions 61a of the arms 61, 61, it is difficult for the end portions 61a to drop off, in comparison with the conventional ball joint structure. That is, the dropping-off of the sliding portion can be prevented.

In addition, the present invention should not be interpreted to be limited to the aforesaid embodiment, but it should be understood that suitable changes and improvements can be performed.

For example, although the joint structure for a toy of the present invention has been described by showing the example in which the joint structure is applied to the chassis coupling portions of the automobile toy, in the aforesaid embodiment, the present invention is not limited to this application example. The present invention can be applied to many structures as long as two members for a toy are coupled to each other in a rockable state.

Furthermore, the hemispherical projecting portions and the hemispherical concave portions, which are formed at the end portions 61a of the arms 61, 61 and the coupling portions 55 of the front wheel chassis 5, are not limited to the configurations of the aforesaid embodiment. That is, the configuration may be changed as long as the configuration includes the following structures: the arms 61, 61 have the two hemispherical sliding surfaces, formed mutually concentrically and having the same central axis; the front wheel chassis 5 has the upper front wheel chassis 52, including the hemispherical first surface to be slid thereon, which is complementary to one of the two sliding surfaces, and the lower front wheel chassis 51, including the hemispherical second surface to be slid thereon, which is complementary to the other sliding surface; and the upper front wheel chassis 52 and the lower front wheel chassis 51 nip the end portions 61a of the arms 61, 61, with the one sliding surface and the first surface to be slid, slidable on each other, and with the other sliding surface and the second surface to be slid, slidable on each other, respectively.

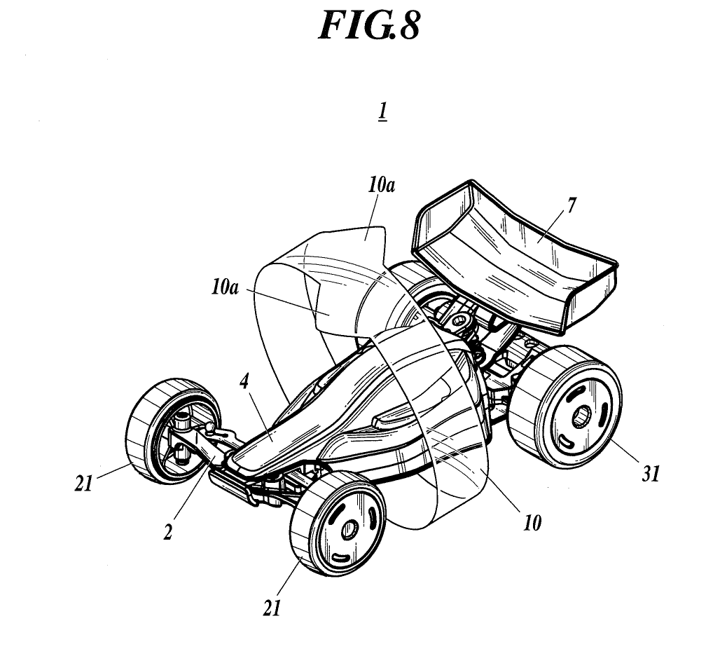

Furthermore, as shown in FIG. 8, it is preferable to provide an overturn prevention ring 10, shaped in almost a belt, on the automobile toy 1. The overturn prevention ring 10 is made of a transparent polycarbonate and is fixed to the back surface of the lower front wheel chassis 51 to enclose the automobile toy 1 at almost the central part in the front and rear direction. Furthermore, two projections 10a, 10a are formed at the top end of the overturn prevention ring 10 projecting into the front and rear direction. The positions of the two projections 10a, 10a in the circumferential direction are different from each other, with the center of the vehicle width direction between the two projections 10a, 10a. By providing such an overturn prevention ring 10, the automobile toy 1 can be protected, and further if the automobile toy 1 is likely to overturn, the overturn prevention ring 10 touches a wall or a road surface to make it possible that the automobile toy 1 restores its posture. Furthermore, even if the automobile toy 1 has been inverted, the projections 10a, 10a make the inversion state unstable, because the automobile toy 1 is supported by a pointed end of one of the projections 10a, 10a. Therefore, the posture of the automobile toy 1 can be restored by causing a reaction by steering the front wheels 21, 21 or driving the rear wheels 31, 31.

The entire disclosure of Japanese Patent Application No. 2010-006633 filed on Jan. 15, 2010 including description, claims, drawings, and abstract are incorporated herein by reference in its entirety.

Although various exemplary embodiments have been shown and described, the invention is not limited to the embodiments shown. Therefore, the scope of the invention is intended to be limited solely by the scope of the claims that follow.

What is claimed is:

1. A joint structure for a toy, comprising:
a male body including;
two hemispherical sliding surfaces formed mutually concentrically and having a same central axis; and
a female body, coupled to the male body with the male body and the female body rockable with each other, the female body including;
a first female body having a hemispherical first surface to be slid complementary to one of the two sliding surfaces; and
a second female body having a hemispherical second surface to be slid complementary to the other of the two sliding surfaces; wherein
the first female body and the second female body nip the male body, with the one sliding surface and the first surface to be slid, slidable on each other, and with the other sliding surface and the second surface to be slid, slidable on each other.

2. The joint structure for a toy according to claim 1, wherein
the first female body includes a hemispherical first projecting portion;
the male body includes a hemispherical first concave portion complementary to the first projecting portion, and a hemispherical second projecting portion projecting toward a direction opposite to the first concave portion, with the first concave portion and the second projecting portion mutually concentric;
the second female body includes a hemispherical second concave portion complementary to the second projecting portion; and
the first female body and the second female body nip the male body with the first projecting portion and the first concave portion fitted to each other slidably, and with the second projecting portion and the second concave portion fitted to each other slidably.

3. The joint structure according to claim 1, wherein
each of the male body, the first female body, and the second female body is made of an elastic member.
